(19) United States
(12) Patent Application Publication
(10) Pub. No.: US 2010/0227657 A1
(43) Pub. Date: Sep. 9, 2010

(54) WIRELESS COMMUNICATION DEVICE

(75) Inventors: Nobuharu Mashima, Sendai-shi (JP); Yoshihiro Kanasaki, Sendai-shi (JP); Hideo Nakanishi, Yokohama-shi (JP)

Correspondence Address: Seed Intellectual Property Law Group PLLC, 701 Fifth Avenue, Suite 5400, Seattle, WA, 98104, US

(73) Assignee: PANASONIC CORPORATION, Kadoma-shi, Osaka (JP)

(21) Appl. No.: 12/678,133

(22) PCT Filed: Sep. 14, 2007
(86) PCT No.: PCT/JP2007/067971

§ 371 Date: Mar. 12, 2010

(51) Int. Cl. H04W 88/02

(52) U.S. Cl. 455/575.4

(57) ABSTRACT

A wireless communication device is equipped with a first housing having a first circuit board; a second housing that is provided at one end of the first housing so as to freely open and close with respect to the first housing and that has a second circuit board and an audio input section; and a third housing that is provided at the other end of the first housing so as to be reclosably open with respect to the first housing and that has a third circuit board and an audio output section. A portion of the second housing overlaps a portion of the first housing while the second housing remains open with respect to the first housing. The first housing has a first conductive terminal disposed at a position on the first circuit board that overlaps a portion of the second housing while the second housing remains open with respect to the first housing. The second housing has a second conductive terminal, which is electrically connected to the first conductive terminal while the second housing remain open, at a position on the second circuit board that overlaps a portion of the first housing while the second housing remains open with respect to the first housing. The first circuit board has a power feeding section. The first circuit board and the second circuit board makeup a dipole antenna when the second housing is opened with respect to the first housing.

### TECHNICAL FIELD

The present invention relates to a wireless communication device that exerts a small effect on a human body and that exhibits high antenna performance.

### BACKGROUND ART

The number of applications installed in a portable phone recently increases, and a user's usage pattern also becomes diversified. Although a straight type and a folding type have hitherto been dominant as a housing structure of a portable phone, portable phones having new housing structures, such as a slide type structure and a two-axis turning type structure, have therefore been contrived. As mentioned above, the housing structure of an electronic device, such as a portable phone, is always experiencing evolution, and contrivance of another new housing structure is expected in future.

For instance, a sliding portable phone 600A, which is shown in FIG. 7 described in Patent Document 1, includes a main housing 100 having at least a display section 101 and input operation sections 102A and 102B, a first movable housing 610A that has a transmitter section 611 and that is slidably engaged with an upper portion of the main housing 100, and a second movable housing 620A that has a receiver section 621 and that is slidably engaged with a lower portion of the main housing 100. When both the first movable housing 610A and the second movable housing 620A are in a closed state, both the movable housings 610A and 620A cover the entirety of the display section 101 and the input operation sections 102A and 102B of the of the main housing 100.

The electronic device having a wireless communication function, like a portable phone, has an antenna. Since the performance of the antenna is affected by the type of an adopted antenna or the layout of an antenna in an housing, the antenna must separately be designed in conformance with an housing structure of an electronic device so that the antenna can exhibit appropriate performance.

For instance, a folding wireless communication device, which is shown in FIG. 8 described in Patent Document 2, has a dipole antenna 2 provided on a first housing 5 and a conductor 12 provided on a second housing 8. The conductor 12 is provided so as to oppose the dipole antenna 2 while the housing is folded and acts as a passive element. Therefore, deterioration of an impedance characteristic of the antenna, which would otherwise arise while the housing is folded, is prevented, so that a stable antenna characteristic can be exhibited. According to Patent Document 1, the effect is not limited to the folding wireless communication device having two housings shown in FIG. 8 and also implemented by a folding wireless communication device having three housings shown in FIG. 9.

In a portable phone shown in FIG. 10 described in Patent Document 3, an antenna housing section 14 made from a nonconductive member into a box shape is disposed at a step 11B formed on an upper end on the back of an housing case 11 so as to be slidably in a vertical direction. An inverted-F antenna element making up a plate-like inverted-F antenna (PIFA) is held in the antenna housing 14. When inserted in the step 11B, the antenna housing section 14 operates as a PIFA. On the contrary, when pulled out of the step 11B, the antenna housing section operates as a monopole antenna. The antenna that comes in different types according to the status of the antenna housing section 14 is thus employed in the portable phone.

Patent Document 1: JP-A-2004-72285

Patent Document 2: JP-A-10-84406

Patent Document 3: JP-A-2002-176307

### DISCLOSURE OF THE INVENTION

### Problem that the Invention is to Solve

A specific absorption rate (SAR) is available as an index for evaluating influence of an electromagnetic wave transmitted from a wireless communication device on a human body. An SAR value shows the amount of energy absorbed by a unit mass of tissue during a unit time and makes it possible to ascertain the amount of energy that the human body has received from a wireless communication device for a given period of time. In particular, a local SAR is used for a portable phone that is used nearby a human head. A portable phone exhibiting a large SAR value exerts a great effect on a human body during a call and undergoes unfavorable degradation of call performance attributable to absorption of energy. If an antenna output is reduced, the SAR value will become smaller. However, when the antenna output is small, performance of the portable phone is deteriorated. For this reason, a portable phone that exhibits a small SAR value and that exhibits high performance is desirable.

When a dipole antenna is used, high performance is obtained over a wide frequency band. A wireless communication device, such as a portable phone having a dipole antenna, is therefore desirable.

An object of the present invention is to provide a wireless communication device that exerts little effect on a human body during a phone and that exhibits high antenna performance.

### Means for Solving the Problem

The present invention provides a wireless communication device comprising: a first housing having a first circuit board; a second housing provided at one end of the first housing so as to freely open and close with respect to the first housing and that has a second circuit board and an audio input section; and a third housing provided at the other end of the first housing so as to freely open and close with respect to the first housing and that has a third circuit board and an audio output section. A portion of the second housing overlaps a portion of the first housing in a state that the second housing is opened with respect to the first housing. The first housing has a first conductive terminal disposed at a position on the first circuit board. The position on the first circuit board overlaps a portion of the second housing in a state that the second housing is opened with respect to the first housing. The second housing has a second conductive terminal which is electrically connected to the first conductive terminal in a state that the second housing is opened with respect to the first housing, the second conductive terminal disposed at a position on the second circuit board that overlaps a portion of the first housing in a state that the second housing is opened with respect to the first housing. The first circuit board has a power feeding section. The first circuit board and the second circuit board are configured as a dipole antenna when the second housing is opened with respect to the first housing.

In the wireless communication device, the second housing has an antenna element having a third conductive terminal electrically connected to the first conductive terminal in a state that the second housing is closed with respect to the first housing.

In the wireless communication device, the antenna element serves as a monopole antenna when the second housing is opened with respect to the first housing.

In the wireless communication device, the power feeding section is provided at a position on the first circuit board that overlaps a portion of the second housing in a state that the second housing is opened with respect to the first housing.

In the wireless communication device, the third housing has a third circuit board connected to the second circuit board through an inductor.

In the wireless communication device, the second housing and the third housing slide over the first housing to move to an open state or an closed state.

In the wireless communication device, a signal processing section that performs signal processing for wireless communication using the dipole antenna or the monopole antenna is provided on the first circuit board.

### ADVANTAGE OF THE INVENTION

According to a wireless communication device of the present invention, the first circuit board and the second circuit board are configured as the dipole antenna in a state that the second housing and the third housing are opened with respect to the first housing. When the user makes a phone call while holding an audio output section to his/her ear in the open state, a distance from the user's head to a power feeding section is long; hence, an SAR value becomes low. Consequently, it is possible to provide a wireless communication device that exerts little effect on a human body during a phone call and that exhibits high antenna performance.

### BRIEF DESCRIPTION OF THE DRAWINGS

FIG. 1(a) is a front view and FIG. 1(b) is a side cross sectional view showing a wireless communication device of a first embodiment.

FIG. 2 is a side cross sectional view of the wireless communication device that makes an electrical connection utilizing capacity coupling.

FIG. 3 is a view showing a positional relationship between the wireless communication device of the first embodiment and a user's head when the user carries out a phone call while a second housing and a third housing are opened with respect to a first housing.

FIG. 4 is a view showing a positional relationship between the wireless communication device of the first embodiment and the user's head when the user carries out a phone call with the second housing being opened and the third housing being closed with respect to the first housing.

FIG. 5 is a side cross sectional view showing a wireless communication device of a second embodiment.

FIG. 6 is a side cross sectional view showing a wireless communication device in which the third housing is eliminated from the wireless communication device of the first embodiment.

FIG. 7 is a view showing a sliding portable phone described in JP-A-2004-72285.

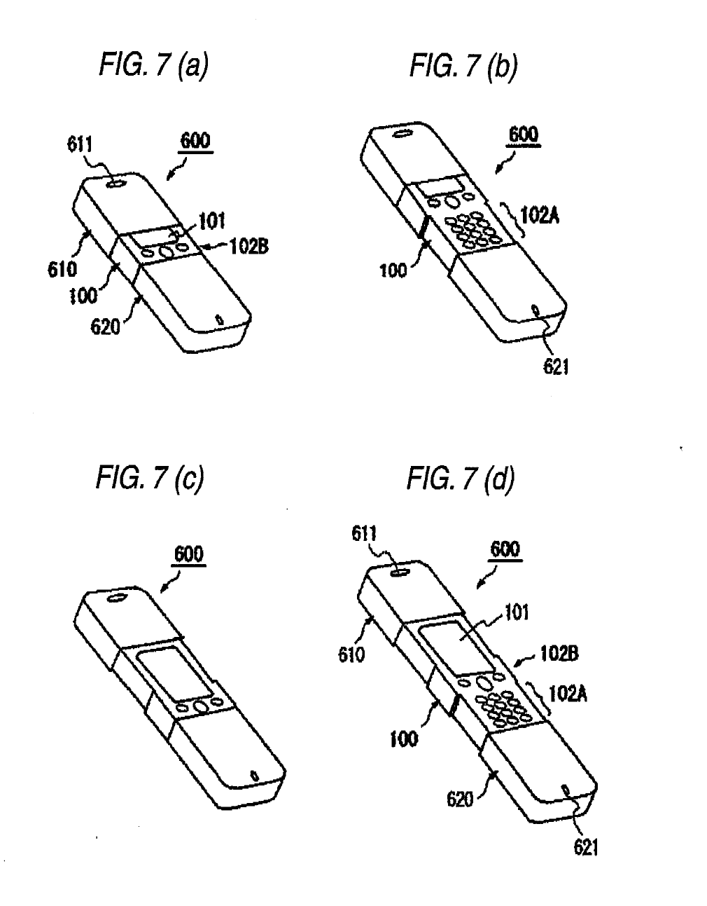

FIG. 8 is a view showing a folding wireless communication device two housings that is described in JP-A-10-84406.

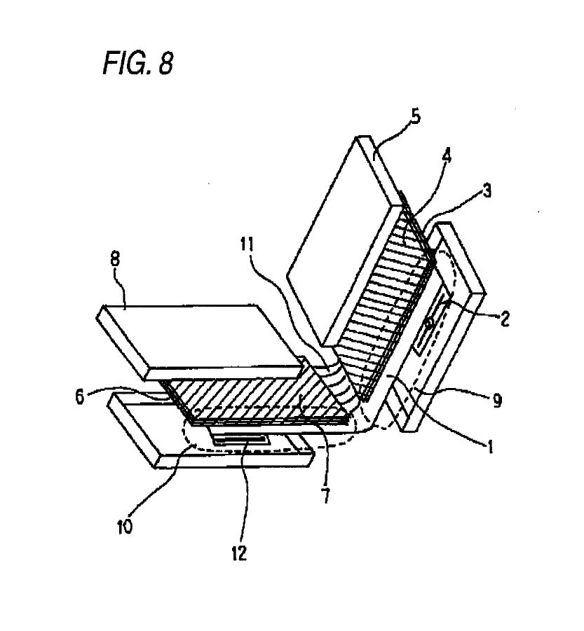

FIG. 9 is a view showing a folding wireless communication device having three housings that is described in JP-A-10-84406.

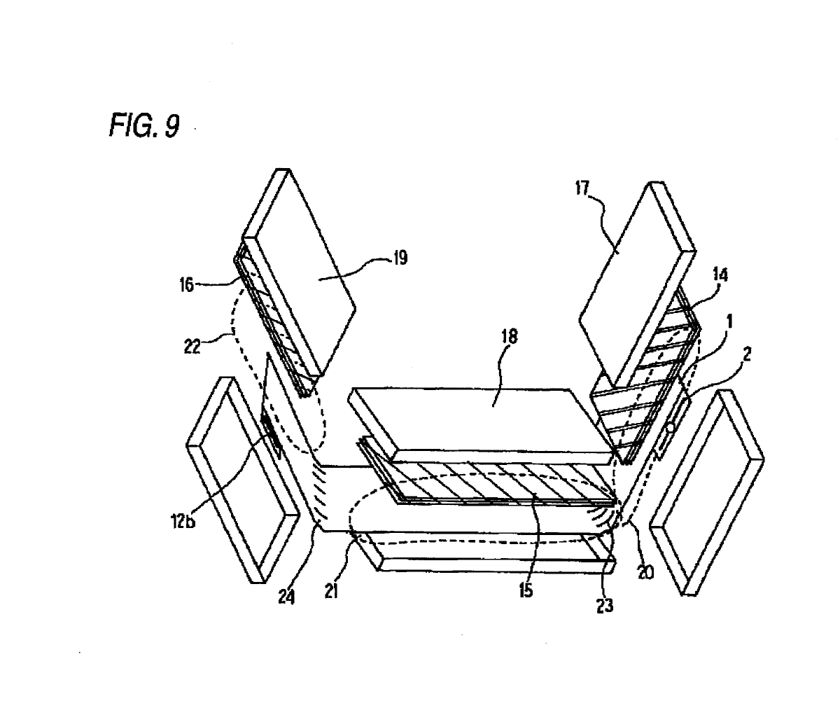

FIG. 10 is a view showing a portable phone described in JP-A-2002-176307.

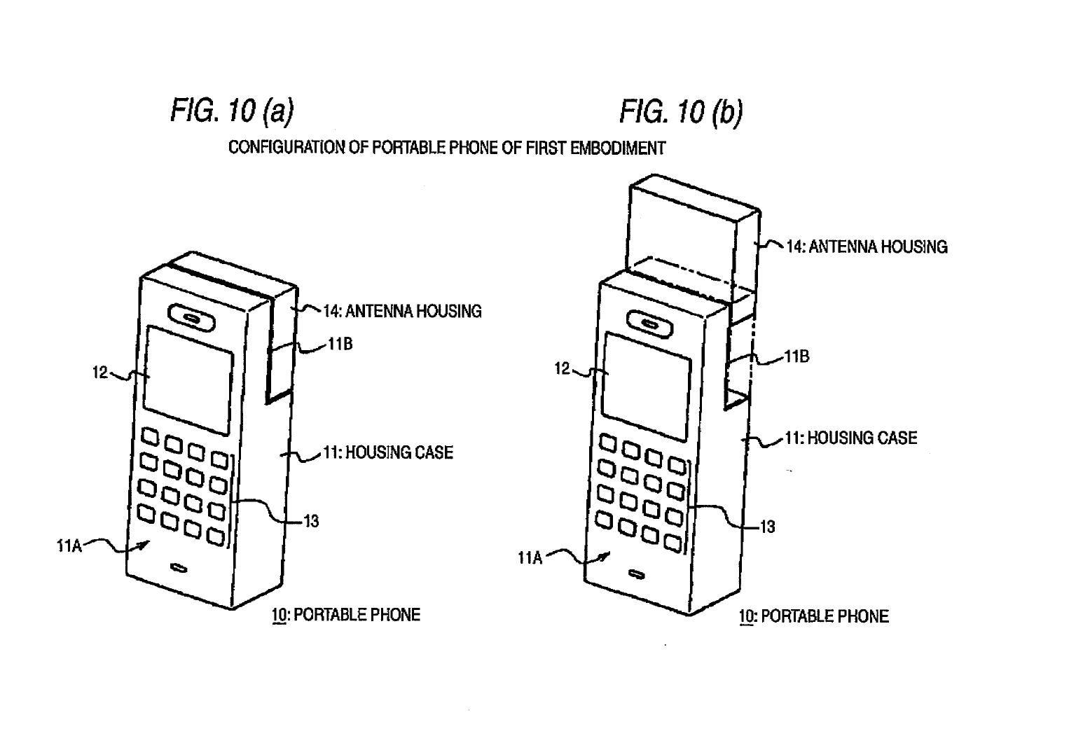

### DESCRIPTIONS OF THE REFERENCE NUMERALS AND SYMBOLS

110 FIRST HOUSING

113 FIRST CIRCUIT BOARD

115 CONDUCTIVE TERMINAL

117 POWER FEEDING SECTION

120 SECOND HOUSING

121 SECOND CIRCUIT BOARD

123 MONOPOLE ANTENNA

125 MICROPHONE

127 CONDUCTIVE TERMINAL

129 CONDUCTIVE TERMINAL

130 THIRD HOUSING

131 THIRD CIRCUIT BOARD

133 SPEAKER

151 ANTENNA ELEMENT

153 CONDUCTIVE TERMINAL

155 CONDUCTIVE SECTION

157 CONDUCTIVE PLATE

### BEST MODES FOR IMPLEMENTING THE INVENTION

Embodiments of the present invention are hereinbelow described by reference to the drawings.

### First Embodiment

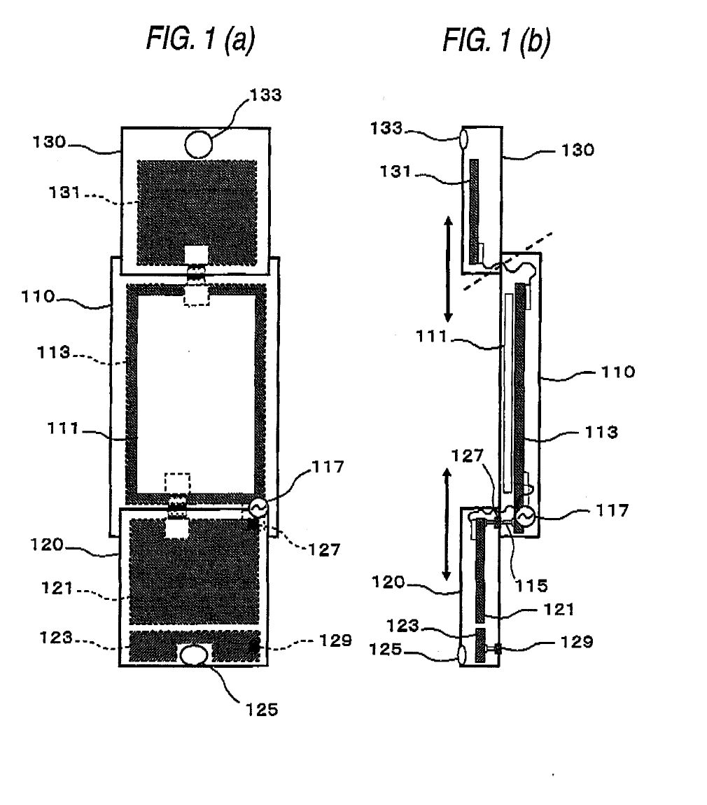

FIG. 1 is a block diagram showing a wireless communication device of a first embodiment. FIG. 1(a) is a front view showing the wireless communication device in an open state, and FIG. 1(b) is a side cross sectional view showing the wireless communication device in the open state. As shown in FIG. 1, the wireless communication device of the first embodiment has a first housing 110, a second housing 120, and a third housing 130. The second housing 120 and the third housing 130 are provided so as to be able to slide over the first housing 110 and so as to be opened and closed with respect to the first housing 110. The first housing 110 has a display section 111. When the second housing 120 and the third housing 130 are closed with respect to the first housing 110, the display section 111 is covered with the second housing 120 and the third housing 130. If the length of the first housing 110 is taken as P1; the length of the second housing 120 is taken as P2; and the length of the third housing 130 is taken as P3, a relationship among longitudinal lengths of the respective housings is defined as P1>P2≈P3.

The first housing 110 has therein a first circuit board 113 which is provided on the back of the display section 111. The first circuit board 113 has a signal processing section that performs signal processing for the purpose of wireless communication. The signal processing section processes a high-frequency signal. The second housing 120 has therein a second circuit board 121, a monopole antenna 123, and a microphone 125. The third housing 130 has therein a third circuit board 131 and a speaker 133. The third circuit board 131 and the first circuit board 113 are connected together by means of an unillustrated inductor. The inductor reduces influence of high frequency noise, which is generated from the first circuit board 113, on the third circuit board 131.

A conductive terminal 115 is provided on a face of the first circuit board 113 included in the first housing 110, the face of the first circuit board 113 opposing to the second housing 120. Meanwhile, a conductive terminal 127 is provided on a face of the second circuit board 121 included in the second housing 120, the face of the second circuit board 121 opposing to the first housing 110. The conductive terminal 127 contacts the conductive terminal 115 when the second housing 120 is opened with respect to the first housing 110 (hereinafter simply called an “open state”) Each of the conductive terminal 127 and the conductive terminal 129 has a spring. An end portion which is contacted with the conductive terminal 115 is extended and contracted by the spring.

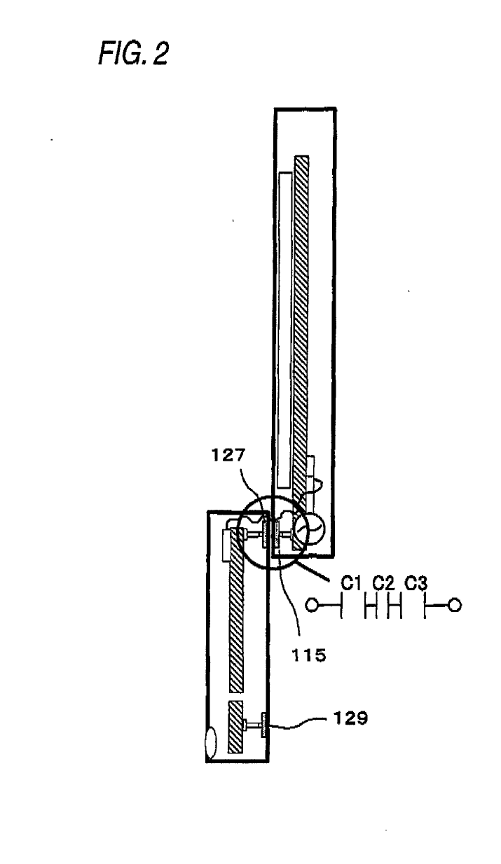

A connection between the conductive terminal 115 and the conductive terminals 127 and a connection between the conductive terminal 115 and the conductive terminals 129 are not limited to the connection implemented by expansion and contraction of the spring. As shown in FIG. 2, the connection may also be implemented by an electrical connection utilizing capacity coupling. In the case of an electrical connection utilizing capacity coupling, each of the conductive terminals 115, 127, and 129 has an area that enables performance of capacity coupling. The conductive terminals are placed at positions where the conductive terminal 115 and the conductive terminal 127 overlap each other in parallel at an open state and where the conductive terminal 115 and the conductive terminal 129 overlap each other in parallel at a closed state. The conductive terminals can assume any shape, so long as overlap areas of each of the conductive terminals can be assured.

In a configuration in which the conductive terminals are connected by means of expansion and contraction of the spring, the conductive terminals remain uncovered. However, in a form of an electrical connection utilizing capacitive coupling, the conductive terminals operate even while covered with the housing, so that design limits can be lessened.

As shown in FIG. 1, even in an open state, the second housing 120 and the third housing 130 partially overlap the first housing 110, and the first circuit board 113 and the second circuit board 121 also partially overlap each other. The conductive terminal 115 on the first circuit board 113 and the conductive terminal 127 on the second circuit board 121 are disposed at areas where the first circuit board 113 and the second circuit board 121 overlap each other in the open state. Specifically, the conductive terminal 115 is disposed in the vicinity of an area above the end of the first circuit board 113 close to the second housing 120. The conductive terminal 127 is disposed in the vicinity of an area above the end of the second circuit board 121 close to the first housing 110.

Further, a power feeding section 117 is disposed at a position on the first circuit board 113 within the overlap area between the first circuit board 113 and the second circuit board 121 in the open state. In the open state, the conductive terminal 115 on the first circuit board 113 and the conductive terminal 127 on the second circuit board 121 contact each other. Therefore, the first circuit board 113 and the second circuit board 121 are configured as a dipole antenna. Meanwhile, in the closed state, the conductive terminal 115 on the first circuit board 113 and the conductive terminal 129 of the monopole antenna 123 contact each other. Hence, power is fed from the power feeding section 117 to the monopole antenna 123.

As mentioned above, in the wireless communication device of the present embodiment, the dipole antenna configured by the first circuit board 113 and the second circuit board 121 is used in the open state, and the monopole antenna 123 is used in the closed state. The dipole antenna exhibits high performance over a wide frequency band when compared with the monopole antenna. Therefore, the wireless communication device of the present embodiment is opened, whereby high performance can be achieved over a wider frequency band than the frequency band in a state that the wireless communication device is closed.

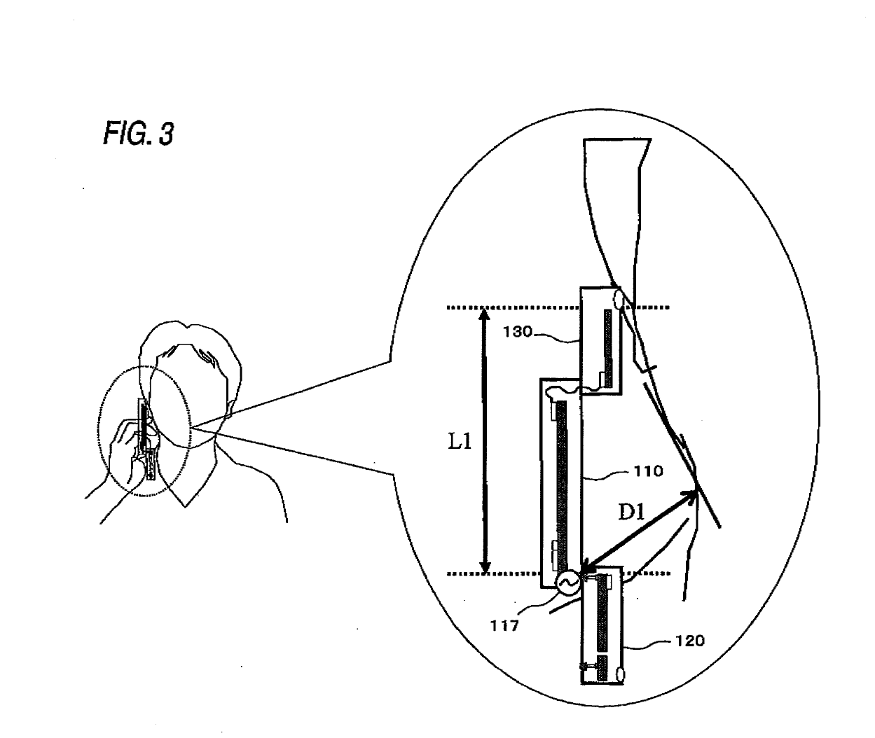

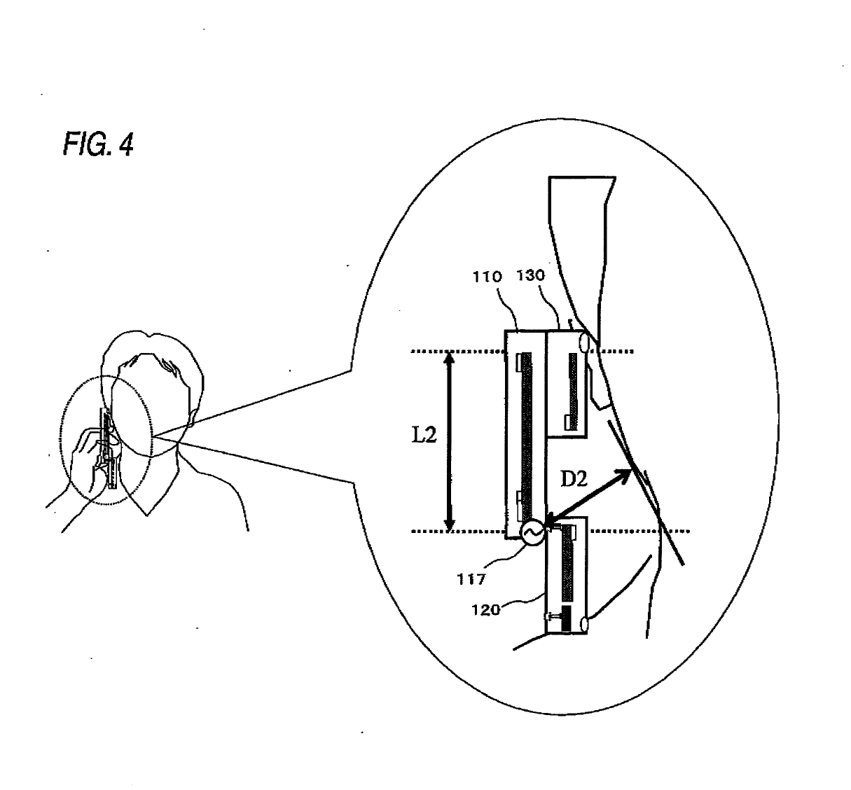

FIG. 3 is a view showing a positional relationship between the wireless communication device of the first embodiment and a user's head when the user carries out a phone call while the second housing 120 and the third housing 130 are opened with respect to the first housing 110, FIG. 4 is a view showing a positional relationship between the wireless communication device of the first embodiment and a user's head when the user carries out a phone call with the second housing 120 being opened and the third housing 130 being closed with respect to the first housing 110. As shown in FIGS. 3 and 4, distances (D1, L1) from the head to the power feeding section 117 in the state shown in FIG. 3 are longer than distances (D2, L2) from the head to the power feeding section 117 in a state shown in FIG. 4. As the power feeding section 117 is separated from the head, the SAR value become smaller and the phone performance is also increased. Therefore, when the user makes a phone call, it is better to bring the wireless communication device of the embodiment into a state shown in FIG. 3; namely, a state in which the second housing 120 and the third housing 130 are opened with respect to the first housing 110.

The embodiment describes the monopole antenna 123 as an example antenna used with the second housing 120 being closed with respect to the first housing 110. However, a loop antenna or a plate inverted F antenna (PIFA) can also be employed in place of the monopole antenna 123.

### Second Embodiment

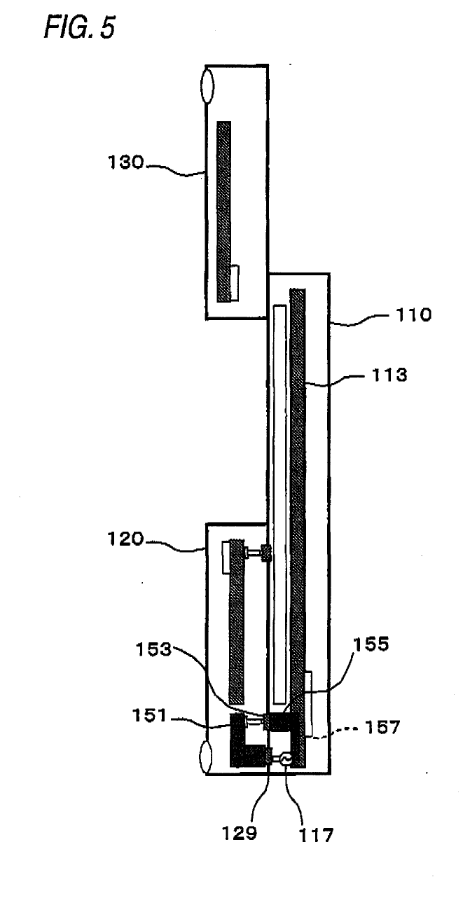

FIG. 5 is a side cross sectional view showing a wireless communication device of a second embodiment. The wireless communication device of the second embodiment differs from the wireless communication device of the first embodiment in that the second embodiment is additionally provided with a configuration for increasing an effective volume of the antenna utilized when the second housing 120 is closed with respect to the first housing 110. The second embodiment is analogous to the first embodiment in other respect, and constituent elements shown in FIG. 5, which are also common to FIG. 1, are assigned the same reference numerals.

The second housing 120 of the present embodiment has therein an antenna element 151 having the same shape (a rectangular shape) as that of the monopole antenna 123 described in the first embodiment. A conductive terminal 129 is provided at one end of the antenna element 151, and a conductive terminal 153 is provided at the other end. The conductive terminal 129 provided at one end of the antenna element 151 contacts the conductive terminal 115 on the first circuit board 113 in the closed state.

The first housing 110 of the present embodiment has therein a rectangular conductive plate 157 in addition to the first circuit board 113. The conductive plate 157 is insulated from the first circuit board 113. A conductive section 155 is provided at a position on the conductive plate 157 where the conductive section contacts the conductive terminal 153 of the antenna element 151 in the closed state. The conductive terminal 153 provided at the other end of the antenna element 151 contacts the conductive section 155 of the conductive plate 157 in the closed state.

According to the foregoing configuration, the constituent element utilized as the antenna in the closed state is not limited to the antenna element 151. The conductive plate 157 provided on the first housing 110 is also included in the constituent element utilized as the antenna. Therefore, an effective volume of the antenna that is larger than the effective volume of the monopole antenna 123 described in the first embodiment can be assured. Since the effective volume of the antenna is large, sensitivity is enhanced. Therefore, high performance antenna can be utilized even in the closed state.

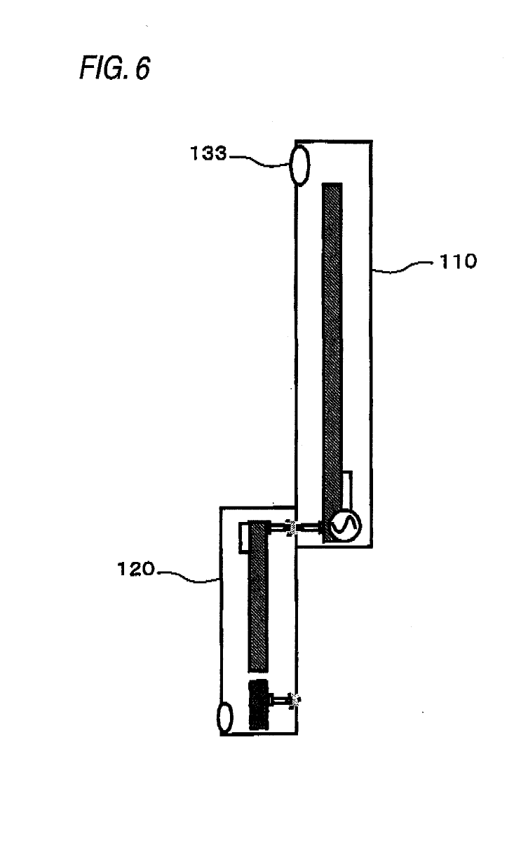

The wireless communication devices described in the first and second embodiments in the above have the slidable second housing 120 and the slidable third housing 130 that are provided at both ends of the first housing 110. However, as shown in FIG. 6, the third housing 130 may also be eliminated. Moreover, in the first and second embodiments, the second housing 120 and the third housing 130 are slid to open and close with respect to the first housing 110. However, there can also be adopted a structure in which hinges are provided at both ends of the first end 110, to thus enable the second housing 120 and the third housing 130 to open and close with respect to the first housing 110 like a gatefold.

Although the present invention has been described in detail by reference to the specific embodiments, it is manifest to those skilled in the art that the present invention be susceptible to various alterations and modifications without departing the spirit and scope of the invention.

### INDUSTRIAL APPLICABILITY

A wireless communication device of the present invention is useful as a portable phone, or the like, that exerts little effect on a human body during a phone call and that exhibits high antenna performance.

1. A wireless communication device comprising:
a first housing having a first circuit board;
a second housing provided at one end of the first housing so as to freely open and close with respect to the first housing and that has a second circuit board and an audio input section; and
a third housing provided at the other end of the first housing so as to freely open and close with respect to the first housing and that has a third circuit board and an audio output section,
wherein respective lengths of the second and third housings are smaller than a length of the first housing in an opening and closing direction;
wherein the second housing is away from a head of a user than the third housing when the user makes a phone call;
wherein a portion of the second housing overlaps a portion of the first housing in a state that the second housing is opened with respect to the first housing;
wherein the first housing has a first conductive terminal disposed at a position on the first circuit board, the position on the first circuit board being overlapping a portion of the second housing in a state that the second housing is opened with respect to the first housing;
wherein the second housing has a second conductive terminal which is electrically connected to the first conductive terminal in a state that the second housing is opened with respect to the first housing, the second conductive terminal disposed at a position on the second circuit board that overlaps a portion of the first housing in a state that the second housing is opened with respect to the first housing;
wherein the first circuit board has a power feeding section; and
wherein the first circuit board and the second circuit board are configured as a dipole antenna when the second housing is opened with respect to the first housing.

2. The wireless communication device according to claim 1, wherein the second housing has an antenna element having a third conductive terminal electrically connected to the first conductive terminal in a state that the second housing is closed with respect to the first housing.

3. The wireless communication device according to claim 2, wherein the antenna element serves as a monopole antenna when the second housing is opened with respect to the first housing.

4. The wireless communication device according to claim 1, wherein the power feeding section is provided at a position on the first circuit board that overlaps a portion of the second housing in a state that the second housing is opened with respect to the first housing.

5. The wireless communication device according to claim 1, wherein the third housing has a third circuit board connected to the second circuit board through an inductor.

6. The wireless communication device according to claim 2, wherein the second housing and the third housing slide over the first housing to move to an open state or an closed state.

7. The wireless communication device according to claim 3, wherein a signal processing section that performs signal processing for wireless communication using the dipole antenna or the monopole antenna is provided on the first circuit board.
